(19) United States
(12) Patent Application Publication
(10) Pub. No.: US 2003/0009582 A1
(43) Pub. Date: Jan. 9, 2003

(54) Distributed information management schemes for dynamic allocation and de-allocation of bandwidth

(76) Inventors: Chunming Qiao, Williamsville, NY (US); Dahai Xu, North Tonawanda, NY (US)

Correspondence Address: LIEBERMAN & NOWAK LLP, 350 FIFTH AVE., SUITE 7412, NEW YORK, NY, 10118, US

(21) Appl. No.: 10/180,191

(22) Filed: Jun. 26, 2002

Related U.S. Application Data
(60) Provisional application No. 60/301,367, filed on Jun. 27, 2001.

(51) Int. Cl. G06F 15/16

(52) U.S. Cl. 709/233; 709/239

(57) ABSTRACT

The invention is a novel and efficient distributed control scheme for dynamic allocation and de-allocation of bandwidth.

The scheme can be applied to MPLS or MPλS networks where bandwidth guaranteed connections (either protected against single link or node failure, unprotected or pre-emptable) need be established and released in a on-line fashion. It can be implemented as a part of the G-MPLS control framework.

It achieves near optimal bandwidth sharing with only partial (aggregated) information, fast path determination and low processing and signaling overhead.

Further, it can allocate and de-allocate bandwidth effectively as a request arrives, avoiding the need for complex optimization operations through e.g., network reconfiguration.

### RELATED APPLICATIONS

This application is based on a U.S. Provisional Application, Serial No. 60/301,367, filed on Jun. 27, 2001, entitled “Distributed Information Management Schemes for Dynamic Allocation and De-allocation of Bandwidth.”

### FIELD OF THE INVENTION

This invention relates to methods for the management of network connections, providing dynamic allocation and de-allocation of bandwidth.

References

[1] Murali Kodialam and T V. Lakshman, “Dynamic routing of bandwidth guaranteed tunnels with restoration,”in INFOCOM'00, 2000, pp. 902-911.

[2] J. W. Suurballe and R. E. Tarjan, “A quick method for finding shortest pairs of disjoint pathis,” Networks, vol. 14, pp. 325-336, 1984.

[3] Yu Liu, D. Tipper, and P. Siripongwutikorn, “Approximating optimal spare capacity allocation by successive survivable routing,” in INFOCOM'01, 2001, pp. 699-708.

[4] C.Assi, A. Shami, M. A. Ali, and et al., “Optical networking and real-time provisioning: An integrated vision for the next generation internet,” in IEEE Network, Vol. 15, No. 4, July-August 2001, pp. 36-45.

[5] T. M. Chen and T. H. Oh, “Reliable services in MPLS,” in IEEE Communications Magazine, December 1999, pp. 58-62.

[6] A. Benerjee, J. Drake, J. Lang, and B. Turner et al., “Generalized multiprotocol label switching: An overview of signaling enhancements and recovery techniques,” in IEEE Communications Magazine, Vol. 39, No. 7, July 2001, pp. 144-151.

[7] D. O. Awduche, L. Berger, and et al, “RSVP-TE: Extensions to RSVP for LSP tunnels,” in Draft-ietf-mpls-rsvp-lsp-tunnel-07, August 2000.

[8] Der-Hwa Gan, Ping Pan, and et al., “A method for MPLS LSP fast-reroute using RSVP detours,” in Draft-gan-fast-reroute-00, April 2001.

[9] B. Doshi and et al., “optical network design and restoration,” Bell Labs Technical Journal, pp. 58-84, January-March 1999.

[10] Yijun Xiong and Lorne G. Mason, “Restoration strategies and spare capacity requirements in self-healing ATM networks,” in IEEE/ACM Trans. on Networking, Vol. 7, No. 1, 1999, pp. 98-110.

[1] Ramu Ramamurthy et al., “Capacity performance of dynamic provisioning in optical networks,” Journal of Lightwave Technology, vol. 19, no. 1, pp. 40-48, 2001.

[12] Chunming Qiao and Dahai Xu, “Distributed partial information management (DPIM) schemes for survivable networks—part I,” in INFOCOM'02, June 2002.

[13] C. Li, S. T. McCormick, and D. Simchi-Levi, “Finding disjoint paths with different path costs: Complexity and algorithms,” in Networks, Vol. 22., 1992, pp. 653-667.

[14] C. Dovrolis and P. Ramanathan, “Resource aggregation for fault tolerance in integrated service networks,” in ACM Computer Communication Review, Vol. 28, No. 2, 1998, pp. 39-53.

[15] Ramu Ramamurthy, Sudipta Sengupta, and Sid Chaudhuri, “Comparison of centralized and distributed provisioning of lightpaths in optical networks,” in OFC'01, 2001, pp. MH4-1.

[16] Ching-Fong Su and Xun Su, “An online distributed protection algorithm in WDM networks,” in ICC'01, 2001.

[17] W. Gander and W. Gautschi, “Adaptive quadrature—revisited,” in BIT, Vol. 40, This document is also available at http://www.inf.ethz.ch/personl/gander, 2000, pp. 84-101.

[18] S. Baroni, P. Bayvel, and R. J.Gibbens, “On the number of wavelength in arbitrarily-connected wavelength-routed optical networks,” in University of Cambridge, Statistical Laboratory Research Report 1998-7, http://www.statslab.cam.ac.uk/reports/1998/1998-7.pdf, 1998.

[19] J. Luciani et al., “IP over optical networks a framework,” in Internet draft, work in progress, March 2001.

[20] D. Papadimitriou et al., “Inference of shared risk link groups,” in Internet draft, work in progress, November 2001.

### BACKGROUND OF THE INVENTION

Many emerging network applications, such as those used in wide-area collaborative science and engineering projects, make use of high-speed data exchanges that require reliable, high-bandwidth connections between large computing resources (e.g., storage with terabytes to petabytes of data, clustered supercomputers and visualization displays) be dynamically set-up and released. To meet the requirements of these applications economically, a network must be able to quickly provision bandwidth-guaranteed survivable connections (i.e., connections with sufficient protection against possible failures of network components).

In such a high-speed network, a link (e.g., an optical fiber) can carry up to a few terabits per second. Such a link may fail due to human error, software bugs, hardware defects, natural disasters, or even through deliberate sabotage by hackers. As our national security, economy and even day-to-day life rely more and more on computer and telecommunication networks, avoiding disruptions to information exchange due to unexpected failures has become increasingly important.

To avoid these disruptions, a common approach is to protect connections carrying critical information from a single link or node, called shared mesh protection or shared path protection. The scheme is as follows: when establishing a connection (the “active connection”) along a path (the “active path”) between an ingress and an egress node, another link-disjoint (or node-disjoint) path (the “backup path”), which is capable of establishing a backup connection between the ingress and egress nodes, is also determined. Upon failure of the active path, the connection is re-routed immediately to the backup path.

Note that in shared path protection, a backup connection does not need to be established at the same time as its corresponding active connection; rather, it can be established and used to re-route the information carried by the active connection after the active connection fails (and before the active connection can be restored). After the link/node failure is repaired, and the active connection reestablished, the backup connection can be released. Because it is assumed that only one link (or node) will fail at any given time (i.e., no additional failures will occur before the current failure is repaired), backup connections corresponding to active connections that are link-disjoint (or node-disjoint) do not need be established in response to any single link (node) failure. Thus, even though these backup connections may be using the same link, they can share bandwidth on the common link.

As an example of bandwidth sharing among the backup connections, consider two connection establishment requests, represented by tuple (sₖ,dₖ,wₖ), where sₖ is the ingress node, dₖ the egress node, and wₖ the amount of bandwidth required to carry information from sₖ to dₖ, for k=1 and 2, respectively. As shown in Figure, since the two active paths A1 and A2 do not share any links or nodes, the amount of bandwidth needed on links common to the two backup paths B1 and B2 such as l is max{w₁,w₂} (not w₁+w₂). Such bandwidth sharing allows a network to operate more efficiently. More specifically, without taking advantage of such bandwidth sharing, additional bandwidth is required to establish the same set of connections; conversely, fewer connections can be established in a network with the same (and limited) bandwidth.

In order to determine whether or not two or more backup connections can share bandwidth on a common link, one needs to know whether or not their corresponding active connections are link (or node) disjoint. This information is readily available when a centralized control is used. A network-wide central controller processes every request to establish/tear-down a connection, and thus can maintain and access information on complete paths and/or global link usage. However, centralized controls are neither robust nor scalable as the central controller can become another point of failure or a performance bottleneck. In addition, the amount of information that needs to be maintained is also enormous when the problem size (i.e., network size and/or number of requests) is large. Finally, no polynomial time algorithms exist to effectively obtain optimal bandwidth sharing, and Integer Linear Programming (ILP) based methods are very time consuming for a large problem size.

The following three schemes, all under centralized control, have been proposed. In each scheme, it is assumed that a central controller knows the network topology as well as the initial link capacity (i.e. Cₐ for every link a).

To aid our discussion, the following acronyms and abbreviations will be used:

NS: No Sharing

SCI: Sharing with Complete Information

SPI: Sharing with Partial Information

(S)SR: (Successive) Survivable Routing

DCIM: Distributed Complete Information Management

DPIM: Distributed Partial Information Management

DPIM-SAM: DPIM with Sufficient cost estimation, Aggressive cost estimation and Minimum bandwidth allocation

WDM: wavelength-division multiplex (or multiplexed)

MPLS: Multi-protocol label switching

MPλS: Multi-protocol Lambda (i.e., wavelength) switching

E: set of directed links in a network (or graph) N. The number of links is |E|.

V: set of nodes in a network. It includes a set of edge nodes Vₑ and a set of core nodes V_{c}. The number of nodes is |V|=|Vₑ|+|V_{c}|.

Cₑ: Capacity of link e.

Aₑ: Set of connections whose active paths traverse link e.

Fₑ=Σ_{kεAe}wₖ: Total amount of bandwidth on link e dedicated to all active connections traversing link e. Each such connection is protected by a backup path.

Bₑ: Set of connections whose backup paths traverse link e.

Gₑ: Total amount of bandwidth on link e that is currently reserved for all backup paths traversing link e. Note that, without any bandwidth sharing, Gₑ=Σ_{kεBe}wₖ, and with some bandwidth sharing, Gₑ will be less (as to be discussed later).

Rₑ: Residual bandwidth on link e. If all connections need be protected, Rₑ=Cₑ−Fₑ−Gₑ (see extension to the case where unprotected and/or pre-emptable connections are allowed for more discussions).

φ^{b}ₐ=Aₐ∩B_{b}: Set of connections whose active paths traverse link a and whose backup paths traverse link b.

δ^{b}ₐ=Σ_{kεφ}^{b}ₐwₖ: Total (i.e. aggregated) amount of bandwidth required by the connections in φ^{b}ₐ. Note that δ^{b}ₐ≦Fₐ. This is the amount of bandwidth on link a dedicated to the active paths for the connections in φ^{b}ₐ. It is also the amount of bandwidth that needs to be reserved on link b for the corresponding backup paths and that may be shared by other backup paths.

θ^{b}ₐ: cost of traversing link b by a backup path for a new connection (in terms of the amount of additional bandwidth to be reserved on link b) when the corresponding active path traverses link a.

G(b): set of δ^{b}ₐ values, one for each link a.

\overline{G}_{b}=max_{∀a}δ^{b}ₐ: Minimum (or necessary) amount of bandwidth that needs to be reserved on link b to backup all active paths, assuming maximum bandwidth sharing is achieved.

F(a): set of δ^{b}ₐ values, one for each link b.

\overline{F}ₐ=max_{∀b}δ^{b}ₐ: Maximum (or sufficient) amount of bandwidth that needs to be reserved on any link, over all the links in a network, in order to backup the active paths currently traversing link a.

In the prior-art No-Sharing scheme, no additional information needs be maintained by the central controller. As the name suggests, there is no bandwidth sharing among the backup connections when using this scheme.

The NS scheme works as follows. For every connection establishment request, the controller tries to find two link-disjoint (or node-disjoint) paths meeting the bandwidth requirement specified by the connection establishment request. Since the amount of bandwidth consumed on each link along both the active and backup paths is wₖ units, the problem of minimizing the total amount of bandwidth consumed by the new connection establishment request is equivalent to that of determining a pair of link-disjoint or node-disjoint paths, where the total number of links involved is minimum. Consequently, the problem can be solved based on minimum cost flow algorithms such as the one described in the Liu, Tipper, and Siripongwutikorn reference.

Although the NS scheme is simple to implement, it is very inefficient in bandwidth utilization.

In another prior art scheme termed Sharing with Complete Information (SCI), the centralized controller maintains the complete information of all existing active and backup connections in a network. More specifically, for every link e, both Aₑ and Bₑ are maintained, and based on which, other parameters such as Fₑ and Gₑ can be determined.

With SCI, the problem of minimizing the total bandwidth consumed to satisfy the new connection request may be solved based on the following Integer Linear Programming (ILP) formulation, as modified from the Kodialam and Lakshman reference: Assume that the active and backup paths for a new connection establishment request which needs w units of bandwidth will traverse links a and b, respectively. In SCI, one can determine that the amount of bandwidth that needs to be reserved on link b is δ^{b}ₐ+w. Since the amount of bandwidth already reserved on link b for backup paths is G_{b} (which is sharable), we have

$${0}_{a}^{b} = \{ \begin{matrix} ∞ & if a = b or {R}_{a} < w oi {δ}_{a}^{b} + w - {G}_{b} > {R}_{b } & ( i ) \\ 0 & else if {δ}_{a}^{b} + w \leq {G}_{b} & ( ii ) \\ {δ}_{a}^{b} + w - {G}_{b} & else if {δ}_{a}^{b} + w > {G}_{b} and {δ}_{a}^{b} + w - {G}_{b} \leq {R}_{b} & ( iii )\end{matrix}$$

In the above equation, (i) states the constraint that the same link cannot be used by both the active and backup paths, and even if a and b are different links, they cannot be used if the residual bandwidth on either link is insufficient; further, (ii) and (iii) state that the new backup path can share the amount of bandwidth already reserved on link b. More specifically, (ii) states no additional bandwidth on link b needs to be reserved in order to protect link a and (iii) states that at least some additional bandwidth on link b should be reserved.

To facilitate the ILP formulation, consider a graph N with a set of vertices (or nodes) V and a set of directed edges (or links) E. Let vector x represent the active path for the new request, where xₑ is set to 1 if link e is used in the active path and 0 otherwise. Clearly, on link e whose xₑ=1 in the final solution, w units of additional bandwidth need to be dedicated. Similarly, let the vector y represent the backup path for the new request, where yₑ is set to 1 if link e is used on the backup path and 0 otherwise. In addition, let zₑ be the additional amount of bandwidth to be reserved on link e for the backup path in the final solution. Clearly, zₑ must be 0 if yₑ=0 in the final solution. Finally, let h(n) be the set of links originating from node n, and t(n) the set of links ending with node n.

The objective of the ILP formulation is to determine active and backup paths (or equivalently, vectors x and y) such that the following cost function is minimized:

$$w \cdot {\sum }_{e ∈ E} {z}_{e} + {\sum }_{e ∈ E} {z}_{e}$$

subject to the following constraints:

$${\sum }_{e ∈ h ( n )} {x}_{e} - {\sum }_{e ∈ l ( n )} {x}_{e} = \{ \begin{matrix}1 & n = s \\ - 1 & n = d \\ 0 & n \neq s , d\end{matrix} \\ {\sum }_{e ∈ h ( n )} {y}_{e} - {\sum }_{e ∈ l ( n )} {y}_{e} = \{ \begin{matrix}1 & n = s \\ - 1 & n = d \\ 0 & n \neq s , d\end{matrix}$$

z_{b}≧θₐ^{b}(xₐ+y_{b}−1)∀a∀b

xₑ,y,ε{0,1}

and

zₑ≧0

As mentioned earlier, such a scheme allows the new backup path to share maximum bandwidth with other existing backup paths but has two major drawbacks that make it impractical for a large problem size. One is the total amount of information (i.e., Aₑ and Bₑ for every link e) that needs to be maintained (which is O(L·|V|), where L is the number of connections, and |V| is the number of nodes in a network), as well as the overhead involved in updating such information for every request (which is O(|V|)). These will likely impose too much of a burden on a central controller. The other is the maximum bandwidth sharing comes at a price of solving the ILP formulation, which contains many variables and constraints, in other words, a high computational overhead. For example, to process one connection establishment request in a 70-node network, it takes about 10-15 minutes on a low-end workstation.

Another prior art scheme we will discuss is called Sharing with Partial Information (SPI). In this scheme, only the values of Fₑ and Gₑ (from which Rₑ can be easily calculated) for every link e are maintained by the central controller.

For SPI, an ILP formulation similar to the one described above can be used. More specifically, one can replace δ^{b}ₐ with·Fₐ in the equation for θ^{b}ₐ (See the Kodialam and Lakshman reference) This is a conservative approach as Fₐ>δ^{b}ₐ,∀b. A quicker method which obtains a near-optimal solution for SPI in about 1 second was also suggested in the Kodialam and Lakshman reference.

$${0}_{a}^{b} = \{ \begin{matrix} ∞ & if a = b or {R}_{a} < w or {F}_{a} + w - {G}_{b} > {R}_{b} & ( {i}^{′} ) \\ 0 & else if {F}_{a} + w \leq {G}_{b} & ( {ii}^{′} ) \\ {F}_{a} + w - {G}_{b} & else if {F}_{a} + w > {G}_{b} and {F}_{a} + w - {G}_{b} \leq {R}_{b} & ( {iii}^{′} )\end{matrix}$$

While the ILP formulation takes as much time to solve as in SCI, SPI achieves a lower bandwidth sharing (and thus lower bandwidth utilization) when compared to SCI as the price paid for maintaining partial information (and thus reducing book-keeping overhead).

The final prior-art scheme we will discuss are so-called Survivable Routing (SR) and Successive Survivable Routing (SSR). In these schemes, instead of maintaining complete path (or per flow) information as in SCI, global link usage (or aggregated) information is maintained. More specifically, in the distributed implementation proposed by the Liu, Tipper, and Siripongwutikorn reference, every (ingress) node maintains a matrix of δ^{b}ₐ for all links a and b. Also, for every connection establishment request, an active path is found first using shortest path algorithms. Then, the links used by the active path is removed, and each remaining link is assigned a cost equal to the additional bandwidth required based on the matrix δ^{b}ₐ, and a cheapest backup path is chosen. After that, the matrix of δ^{b}ₐ is updated and the updated values are broadcast to all other nodes using Link State Advertisement (LSAs).

The main difference between SR and SSR is that, in the latter, existing backup paths may change (in the way they are routed as well as the amount of additional bandwidth reserved) after the matrix δ^{b}ₐ is updated (e.g. as a result of setting up a new connection).

While it has been mentioned in the Kodialam and Lakshman reference that the NS, SPI and SCI schemes described earlier are amendable to implementation under distributed control, no detail of distributed control implementation of any of these schemes has been provided.

Further, even though the Lin, Tipper, and Siripongwutikorn reference provides a glimpse of how paths (active and backup) can be determined, and how the matrix of δ^{b}ₐ can be exchanged under distributed control in SR and SSR, no details on signaling (i.e., how to set up paths) is provided. In addition, every node needs to maintain O(|E|²) information which is still a large amount and requires a high signaling and book-keeping overhead. In fact, in a WDM network where each request is for a lightpath (which occupies an entire wavelength channel on a link it spans), maintaining the complete path information (i.e., Aₑ and Bₑ) as in SCI may not be worse than maintaining the matrix δ^{b}ₐ.

Therefore, an object of the instant invention is to provide an improved distributed control implementation where each controller needs only partial (O(|E|)) information.

It is another object to address the handling of connection release requests (specifically, de-allocate bandwidth reserved for backup paths) that is not addressed in any prior art, especially under distributed control and with partial information. (In NS, bandwidth de-allocation on backup paths is trivial but in SCI (or SR/SSR), it incurs a large computing, information updating and signaling overhead.) It is a related object to provide a scheme that de-allocates bandwidth effectively under distributed control with only partial information (In SPI, de-allocation of bandwidth along the backup path upon a connection release is impossible).

Performance evaluation results have shown that in a 15-node network, after establishing a couple of hundreds of connections, SPI results in about 16% bandwidth saving when compared to NS, while SCI (SR, SSR) can achieve up to 37%. It is a further object of the invention to provide distributed control schemes based on partial information that can achieve up to 32% bandwidth savings.

### SUMMARY OF THE INVENTION

In order to achieve the above objects, the invention presents distributed control methods for on-line dynamic establishment and release of protected connections which achieve a high degree of bandwidth sharing with low signaling and processing overheads and having distributed information maintenance. Efficient distributed control methods will be presented to determine paths, maintain and exchange partial information, handle connection release requests and increase bandwidth sharing with only partial information.

In the following discussion, it is assumed that connection (establishment or release) requests arrive one at a time, and when each request is processed, no prior knowledge about future requests is available. In addition, once the path taken by an active connection and the path selected by the corresponding backup connection are determined, they will not change during the lifetime of the connection. Further, it is first assumed that all connections are protected, and then the extension to accommodate unprotected and pre-emptable connections will be discussed further below.

### BRIEF DESCRIPTION OF THE DRAWINGS

FIG. 1 is an example showing backup paths and bandwidth sharing among backup paths.

FIG. 2 shows a Base Graph showing a directed network where there is no existing connection at the beginning

FIG. 3(1) shows a connection from nodes A to D with w=5 has been established, using link e₆ on its active path and link e₅ on its backup path.

FIG. 3(2) shows another connection from C to D with w=5 being established.

FIG. 3(3) shows that using the simplest form of DPIM, additional six units of backup bandwidth is required on link e7.

FIG. 3(′) shows that using DPIM-S, only one additional unit is required.

FIG. 4 shows Hop-by-hop Allocation of Minimum Bandwidth (or the M approach) FIG. 4(1) shows the bandwidth allocated after connection A to D is established.

FIG. 4(2) shows the bandwidth allocated after connection C to D is established.

FIG. 4(3) shows that using an ordinary method, one additional unit of bandwidth is needed on e7 for the new connection B to D.

FIG. 4(3′) shows that using the minimum allocation method, no additional bandwidth is needed on e7 for connection B to D.

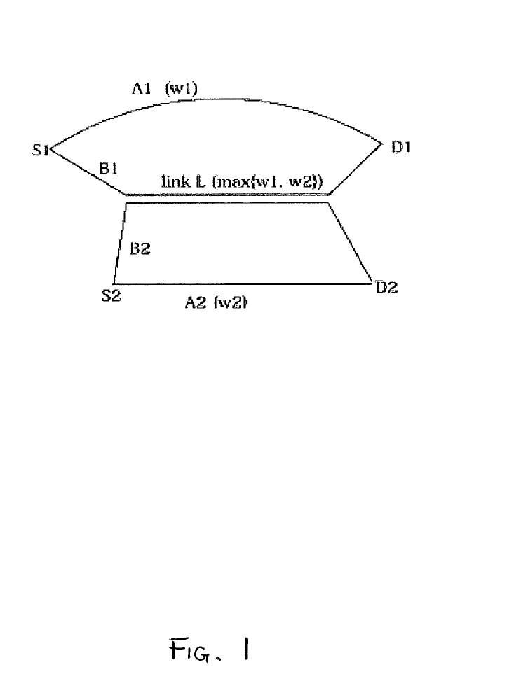

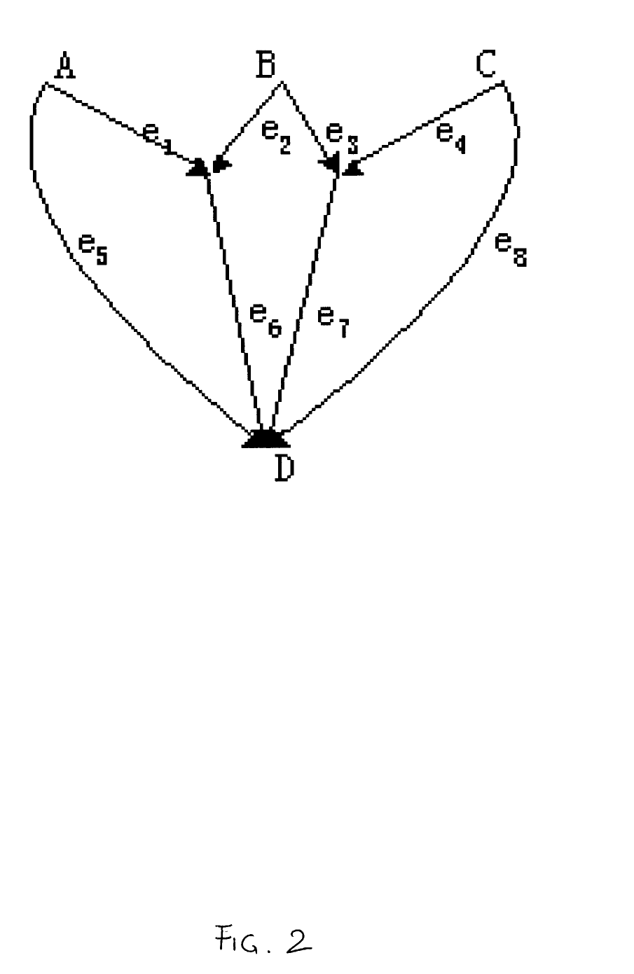

### DETAILED DESCRIPTIONS OF THE PREFERRED EMBODIMENTS

Under distributed control, when a connection establishment request arrives, a controller (e.g. an ingress node) can specify either the entire active and backup paths from the ingress node to the egress node as in explicit routing, or just two adjacent nodes to the ingress node, one for each path to go through next (where another routing decision is to be made) as in hop-by-hop routing. A compromise, called partially explicit routing, is also possible where the ingress node specifies a few but not all nodes on the two paths, and it is up to these nodes to determine how to route from one node to another (possibly in a hop-by-hop fashion).

In the following discussion on the novel schemes based on what we will call “Distributed Partial Information Management (DPIM)”, it is assumed that each request (to either establish or tear-down a connection) arrives at its ingress node, and every edge node (which is potentially an ingress node) acts as a controller that performs explicit routing. Most of the concepts to be discussed also apply to the case with only one such controller (as in centralized control). The same concepts also apply to the case with one or more controllers that perform hop-by-hop routing or partially explicit routing.

In addition, we will assume that each edge node (and in particular, potential ingress node) maintains the topology of the entire network by, e.g., exchanging link state advertisements (LSAs) among all nodes (edge and core nodes) as in OSPF. These edge nodes may exchange additional information using extended LSAs, or dedicated signaling protocols, depending on the implementation.

Information Maintenance

In DPIM, each node n (edge or core) maintains Fₑ, Gₑ and Rₑ for all links eεh(n) (which is very little information though one may reduce it further, e.g., by eliminating Fₑ).

What is novel and unique about DPIM is that each edge (ingress) node maintains only partial information on the existing paths. More specifically, just as a central controller in SPI, it maintains only the aggregated link usage information such as Fₑ, Gₑ and Rₑ for all links eεE. Any updates on such information only need be exchanged among different nodes (and in particular, ingress nodes), as described below.

In addition, each node (edge or core nodes) would also maintain a set of δ^{e}ₐ values for every link e originating from the node. More specifically, for each outgoing link eεh(n) at node n, node n would maintain (up to) |E| entries, one for each link a in the network. Each entry contains the value of δ^{e}ₐ for link aεE (note that one may use a linked list to maintain only those entries whose δ^{e}ₐ>0). Since any given node has a bounded nodal degree (i.e., the number of neighboring nodes and hence the outgoing links) d, the amount of information needs to be maintained is O(d·|E|), which is independent of the number of connections in a network. Based on this set of δ^{e}ₐ values, (which is denoted by G(e)), \overline{G}ₑ can be determined (\overline{G}ₑ=max_{∀a}δ^{e}ₐ). This information is especially useful for de-allocating bandwidth effectively upon receiving a connection tear-down request, and need not be exchanged among different nodes.

In other embodiments of the invention, DPIM implementations can be enhanced to carry additional information maintained by each node. For example, in what we will call DPIM-A (where A stands for Aggressive cost estimation), each node n maintains a set of δ^{b}ₑ values, denoted by F(e), for each link eεh(n). The set F(e), (as a complement to the set G described above), contains (up to) |E| entries of δ^{b}ₑ, one for each link b in the network (note that again, one may use a linked list to maintain only those entries whose δ^{b}ₑ>0). This information is used to improve the accuracy of the estimated cost function and need not be exchanged among different nodes. In addition, each ingress node maintains \overline{F}ₑ (instead of Fₑ), where \overline{F}ₑ=max_{∀b}δ^{b}ₑ, for all links eεE. Just as Gₑ and Rₑ, any updates on \overline{F}ₑ needs to be exchanged among ingress nodes.

In all cases, the amount of information maintained by an edge (or core) node is O(d·|E|) where d is the number of outgoing links and usually small when compared to |E|. In addition, the amount of information that need be exchanged after a connection is set up and released is O(|E|).

Path Determination

In the preferred basic implementation of DPIM, an ingress node determines the active and backup paths using the same Integer Linear Programming formulation as described earlier in our discussion on the prior art SPI scheme (in particular, note equations (i′), (ii′) and (iii′) for the cost estimation function). One can improve the ILP formulation (which affects the performance only slightly) by using the following objective function instead:

$$w {\sum }_{e ∈ E} {x}_{e} + e {\sum }_{e ∈ E} {z}_{e}$$

where [epsilon](<1) is set to 0.9999 in our simulation. One may also protect a connection from a single node failure by transforming the graph N representing the network using a common node-splitting approach described in the Suurballe and Tarjan reference, and then apply the same constraints as those used for ensuring link-disjoint paths.

Note that if the ingress node fails to find a suitable pair of paths because of insufficient residual bandwidth, for example, the connection establishment request will be rejected. Such a request, if submitted after other existing connections have been released, may be satisfied.

The two following methods can be used to improve the accuracy of the estimation of the cost of a backup path, and in turn, select a better pair of active and backup paths.

One is called DPIM-S, where S stands for Sufficient bandwidth estimation. In DPIM-S, equation (iii′) becomes θ^{b}ₐ=min{Fₐ+w−G_{b},w} (instead of θ^{b}ₐ=Fₐ+w−G_{b}) (one should also replace Fₐ+w−G in equations (i′) and (iii′) with min{Fₐ+w−G_{b},w}).

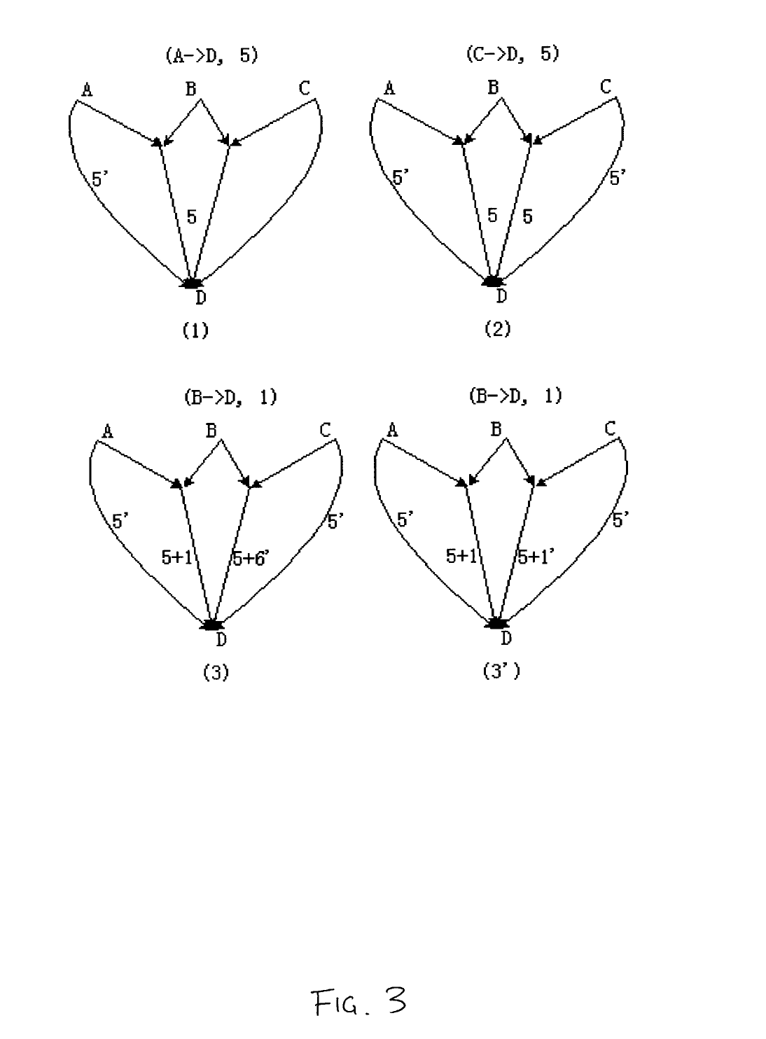

An example showing the improvement due to DPIM-S is as follows. Consider a directed network shown in Figure where there are no existing connections in the beginning. Now assume that a connection from nodes A to D with w=5 has been established, using link e₆ on its active path and link e₅ on its backup path, as shown in FIG. (1). Thereafter, another connection from C to D with w=5 has been established as shown in FIG. (2). In order to establish the third connection from B to D with w=1, DPIM needs to allocate 6 additional units of bandwidth on link e₇ as in FIG. 3 (3) but DPIM-S only needs to allocate 1 additional unit as in FIG. 3(3′).

The other is called DPIM-A, (where A stands for Aggressive cost estimation). In DPIM-A, equation (iii′) becomes θ^{b}ₐ=\overline{F}ₐ+w−G_{b} (one should also replace Fₐ with \overline{F}ₐ in the conditions for equations (i′) through (iii′)). Because Fₐ≧\overline{F}ₐ≧δ^{b}ₐ, such an estimation is closer to the actual cost incurred than if SCI were used.

In another embodiment, the above two cost estimation methods can be combined into what we call DPIM-SA, where equation (iii′s) becomes

θ^{b}ₐ=min{\overline{F}ₐ+w−G_{b}.w}

The above backup cost estimation may lead to long backup paths, thus a longer recovery time as some links may have zero backup cost. An improvement therefore is to use the following cost estimation instead of Equations (ii′) and (iii′):

θ^{b}ₐ=min{max_{∀aεA}(\overline{F}ₐ+w−G_{b},μw),w}

The above cost estimation technique can be used in conjunction with the modified objective function as stated in the beginning of this subsection to yield solutions that not only are bandwidth efficient but also can recovery faster because of shorter backup paths.

In order to determine paths quickly and efficiently, we propose a novel heuristic algorithm called Active Path First (APF) as follows: Assume that DPIM-S is used. It first removes the links e whose Rₑ is less than w from the graph N representing the network, then finds the shortest path (in terms of number of hops) for use as the active path, denoted by A. It then removes the links aεA from the original graph N and calculates, for each remaining link b, min{F_{A}+w−G_{b},w} where F_{A}=max_{∀aεA}Fₐ. If this value exceeds R_{b}, the link b is removed from the graph. Otherwise, it is assigned to the link b as a cost. Finally, a cheapest path is found as the backup path.

If DPIM-SA is used, one can simply replace Fₐ with \overline{F}ₐ (in which F_{A}=max_{∀aεA}\overline{F}ₐ).

In another embodiment, we propose to logically remove all links whose residue bandwidth is less than w, and then find a shortest pair of paths, the shorter of the two shall be the active path and the other the backup path along which minimum amount of backup bandwidth will be allocated using the method to be described below.

We also propose a family of APF-based heuristics which take into account the potential backup cost (PBC) when determining the active path. The basic idea is to assign each link a cost of w+B(w), where B(w) can be defined as follows:

$$B ( w ) = c \cdot w \frac{{\overline{F}}_{a}}{M}$$

where c is a small constant for example between 0 and 1, and M is the maximum value of Fe over all links e.

Alternatively, other PBC functions can be used which returns a non-zero value that is usually proportional to w and Fa. One such example is

$$B ( w ) = w \cdot {ⅇ}^{\frac{- λ {\overline{F}}_{a}}{M}}$$

where λ is also a small constant.

Also, to maintain minimum amount of partial information and require minimum changes to the existing routing mechanisms employed by Internet Protocol (IP), we also propose to remove all remaining links with less than w unit of residue bandwidth and assign each eligible link with cost of w before applying any shortest-path algorithm to find the backup path. This approach can also be bandwidth efficient as long as backup bandwidth allocation is done properly as to be described in the next subsection (using the M-approach).

Finally, to tolerate a single node failure, one can remove the nodes (instead of just links) along the chosen active path first before determining the corresponding backup path.

Path Establishment and Signaling Packets

In DPIM, once the active and backup paths are determined, the ingress node sends signaling packets to the nodes along the two paths. More specifically, let A={aᵢ|i=1,2, . . . p} and B={bⱼ|j=1,2, . . . q} be the set of links along the chosen active and backup paths, respectively. A “connection set-up” packet will then be sent to the nodes along the active path to establish the requested connection, which contains address information on the ingress and egress nodes as well as the bandwidth requested (i.e. w), amongst other information. This set-up process may be carried out in any reasonable distributed manner by reserving w units of bandwidth on each link aᵢεA, creating an switching/routing entry with an appropriate connection identifier (e.g., a label), and configuring the switching fabric (e.g., a cross-connect) at each node along the active path, until the egress node is reached. The egress node then sends back an acknowledgment packet (or ACK).

In addition, a “bandwidth reservation” packet will be sent to the nodes along the chosen backup path. This packet will contain similar information to that carried by the “connection set-up” packet. At each node along the backup path, similar actions will also be taken except that the switching fabric will not be configured. In addition, the amount of bandwidth to be reserved on each link bⱼεB may be less than w due to potential bandwidth sharing. This amount depends on the cost estimation method (e.g., DPIM, DPIM-S, DPIM-A, or DPIM-SA) described above as well as the bandwidth allocation approach to be used, described next.

Bandwidth Allocation on Backup Path

There are two approaches to bandwidth allocation on a backup path. In particular, the information on how much bandwidth to be reserved on each link bⱼεB can be determined either by the ingress node or by node n along the backup path, where bⱼεh(n). More specifically, in the former case, called Explicit Allocation of Estimated Cost (EAEC), the ingress node computes, for all bⱼ, F_{A}=max_{∀aiεA}θ^{b}ⱼₐᵢ appropriately (depending on whether DPIM, DPIM-S, DPIM-A or DPIM-SA is used) and then attach the values, one for each bⱼ, to the “bandwidth reservation” packet. Upon receiving the bandwidth reservation packet, a node n along the backup path allocates the amount of bandwidth specified for an outgoing link bⱼεh(n).

In the latter case, called Hop-by-hop Allocation of Minimum Bandwidth or HAMB (hereafter called the M approach for simplicity where M stands for Minimum), the “bandwidth reservation” packet contains the information on the active path and w. Upon receiving this information, each node n that has an outgoing link eεB updates the set G(e) and then \overline{G}ₑ. Thereafter, the amount of bandwidth to be allocated on link e, denoted by bw, is \overline{G}ₑ−Gₑ if the updated \overline{G}ₑ exceeds Gₑ, and 0 otherwise. In addition, if bw>0, then Gₑ and Rₑ are reduced by bw, and the updated values are multicast to all ingress nodes using either extended LSAs or dedicated signaling protocols.

Note that only p entries in G(e) that correspond to links aᵢεA, where p is the number of links on the active path, need be updated (more specifically, δ^{e}ₐᵢ need be increased by w), and the new value of \overline{G}ₑ is simply the largest among all the entries in G(e), or if the old value of \overline{G}ₑ is maintained, the largest among that and the values of the newly updated p entries.

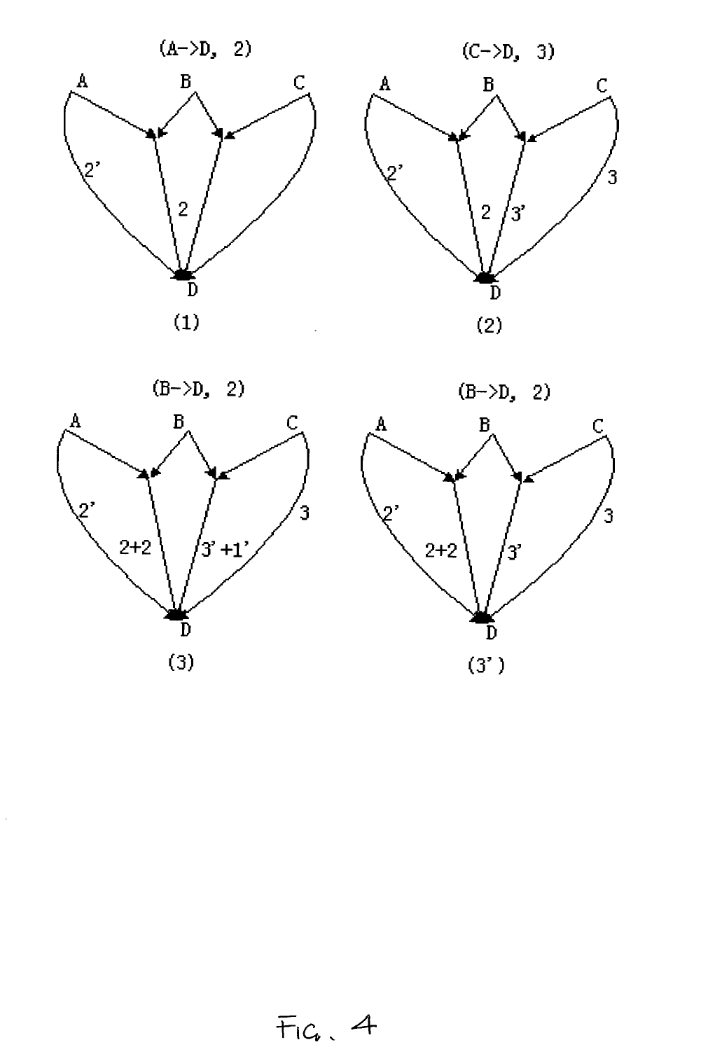

The advantage of the M approach is that it achieves a better bandwidth sharing even than the best EAEC (i.e., EAEC based on DPIM-SA). For example, assume that two connections from A to D and from C to D, have been established as shown in FIG. 4(1) and (2). Consider a new connection from B to D with w=2 which will use e₆ and e₇ on the active and backup paths, respectively. Since \overline{F}ₑ_{⁶}=2 and Gₑ_{⁷}=3 (prior to the establishment of the connection), using EAEC (based on DPIM-SA), one still needs to allocate 1 additional unit of backup bandwidth on e₇ as shown in FIG. 4(3). However, using the M approach, \overline{G}ₑ_{⁷} is still 3 after establishing the connection, so no additional backup bandwidth on e₇ is allocated as in FIG. 4(3′).

Since \overline{G}ₑ is the necessary (i.e., minimum) backup bandwidth needed on link e, hereafter, we will refer to a distributed information management scheme that uses the M approach for bandwidth allocation as either DPIM-M, DPIM-SM, DPIM-AM or DPIM-SAM, depending on whether DPIM, DPIM-S, DPIM-A or DPIM-SA is used for estimating the cost of the paths when determining the paths. When “M” is omitted, the EAEC approach is implied. Note that because in any DPIM scheme, the paths are determined without the complete (global) δ^{b}ₐ information, DPIM-SAM will still under-perform the SCI scheme which always finds optimal active and backup paths. Due to the lack of complete information, DPIM-SAM is only able to achieve near optimal bandwidth sharing in a on-line situation. It is not designed for the purpose of achieving global optimization via, for instance, re-arrangement of backup paths).

More on Bandwidth Allocation on an Active Path

Bandwidth allocation on an active path is a straight-forward matter. However, in either the EAEC or M approach, if DPIM-A (or DPIM-SA) is used to estimate the cost when trying to determine active and backup paths for each request, after the two paths (Active and Backup) are chosen to satisfy a connection-establishment request, a “connection set-up” packet sent to the nodes along the active path will need to carry the information on the chosen backup path in addition to w and other addressing information. Upon receiving such information, each node n that has an outgoing link eεA updates the set F(e) and then \overline{F}ₑ. The updated values of \overline{F}ₑ for every eεA are then multicast to all ingress nodes along with information such as Rₑ.

Note that only q entries in F(e) that correspond to links bⱼεB, where q is the number of links on the backup path, need be updated (more specifically, δ^{b}ⱼₑ need be increased by w), and the new value of \overline{F}ₑ is simply the largest among all the entries in F(e), or if the old value of \overline{F}ₑ is maintained, the largest among that and the values of the newly updated q entries.

Clearly, compared to DPIM or DPIM-S, DPIM-A (or DPIM-SA) requires each node n to maintain set F(e) each outgoing link eεh(n). In addition, it requires that each “connection set-up” packet to carry the backup path information as well as some local computation of \overline{F}ₑ. Nevertheless, our performance evaluation results show that the benefit of DPIM-A in improving bandwidth sharing (and in determining a better backup as described earlier) is quite significant.

Connection Tear-Down

When a connection release request arrives, a “connection tear-down” packet and a “bandwidth release” packet are sent to the nodes along the active and backup paths, respectively. These packets may carry the connection identifier to facilitate the bandwidth release and removal of the switching/routing entry corresponding to the connection identifier. As before, the egress will send ACK packets back.

Bandwidth de-allocation on the links along an active path A is straight-forward unless DPIM-A is used. More specifically, if DPIM-A is not used, w units of bandwidth are de-allocated on each link eεA, and the updated values of Fₑ and Rₑ are multicast to all the ingress nodes. The case where DPIM-A (or DPIM-SA, DPIM-SAM) is used will be described at the end of this subsection.

Although bandwidth de-allocation on the links along a backup path B is not as straight-forward, it resembles bandwidth allocation using the M approach. More specifically, to facilitate effective bandwidth de-allocation, each “bandwidth release” packet will carry the information on the active path (i.e., the set A) as well as w. Upon receiving this information, each node n that has an outgoing link eεB updates the set G(e) and then \overline{G}ₑ. Thereafter, the amount of bandwidth to be deallocated on link e is bw=Gₑ−\overline{G}ₑ≧0. If bw>0, then Gₑ changes to \overline{G}ₑ and Rₑ increases by bw, and the updated values are multicast to all ingress nodes. Note that this implies that each node n needs to maintain Gₑ as well as the set G(e) for each link eεh(n) to deal with bandwidth deallocation, even though such information may seem to be redundant for bandwidth allocation (e.g., when using the EAEC approach).

If DPIM-A (or DPIM-SA) is used, releasing a connection along the active path can be similar to establishing a connection along the active path when DPIM-A (or DPIM-SA) is used. Specifically, each “connection tear-down” packet will contain the set B, and upon receiving such information, a node n that has an outgoing link eεA updates the set F(e) as well as \overline{F}ₑ for link e, and then multicast the updated \overline{F}ₑ to all ingress nodes.

Information Distribution and Exchange Methods

We have assumed that the topological information is exchanged using LSAs as in OSPF. We have also described the information to be carried by the signaling packets used to establish and tear-down a connection. In short, the difference between the two bandwidth allocation approaches, EAEC and M, in terms of the amount of information to be carried by a “bandwidth reservation” or “bandwidth release” packet is not much. If DPIM-A (or DPIM-SA) is used, more information needs be carried by a “connection set-up” or “connection tear-down” packet. But the amount of information is bounded by O(|V|).

Here, we discuss the methods to exchange information such as Fₑ, Gₑ or Rₑ. As mentioned earlier, one method, which we call core-assisted broadcast (or CAB), is to use extended LSAs (or to piggyback the information onto existing LSAs). A major advantage of this method is that no new dedicated signaling protocols are needed. One major disadvantage is that such information, which is needed by the ingress nodes only, is broadcast to all the nodes, which results in unnecessary signaling overhead. Another disadvantage is that the frequency at which such information is exchanged has to be tied up with the frequency at which other LSAs are exchanged. When the frequency is too low relative to the frequency at which connections are set up and torn-down, ingress nodes may not receive up-to-date information on Fₑ, Gₑ or Rₑ and thus will adversely affect their decision-making ability. On the other hand, when the frequency is too high, signaling overhead involved in exchanging this information (and other topological information) may become significant.

To address the deficiencies of the above method, one may use a dedicated signaling protocol that multicast the information to all the ingress nodes whenever it is updated. This multicast can be performed by each node (along either the active or backup path) which updates the information. We call such a method Core-Assisted Multicast of Individual Update (or CAM-IU). Since each signaling packet contains a more or less fixed amount of control information (such as sequence number, time-stamp or error checking/detection codes), one can further reduce signaling overhead by collecting the updated information on either the Rₐᵢ and \overline{F}ₐᵢ for every link aᵢεA or R_{bj} and G_{bj} for every link bⱼεB, in one “updated information” packet, and multicast that packet to all ingress nodes. Such information may be collected in the ACK sent by the egress node to the ingress node, and when the ingress node receives the ACK, it constructs an “updated information” packet and multicasts the packet to all other ingress nodes. We call this type of method “Edge Direct Multicast of Collected (lump sum) Updates” or EDM-CU.

Note that when EAEC is used in conjunction with DPIM or DPIM-S, the amount of bandwidth to be allocated on the active and backup paths in response to a connection establishment request are determined by the ingress node. The ingress node can then update Fₑ, Gₑ and Rₑ for all eεA∪B, and construct such an updated information packet. We call such a method EDM-V (where V stands for value). Also, in such a case, the ingress node may multicast just a copy of the connection establishment request to all other ingress nodes which can then compute the active and backup paths (but will not send out signaling packets), and update Fₑ, Gₑ and Rₑ by themselves. We call such a method FDM-R (where R stands for request). To avoid duplicate path computation at all ingress nodes, the ingress node will compute the active and backup paths and send the path information to all other ingress nodes which update Fₑ, Gₑ and Rₑ. We call this alternative EDM-P (where P stands for path). Note that in either EDM-R or EDM-P, each ingress node will discard the computed/received path information after updating Fₑ, Gₑ and Rₑ.

Note also that EDM-V, EDM-P and EDM-R do not work when either a connection tear-down request is received, DIM-A or DIM-SA is used, or simply the M approach is used to allocate bandwidth (instead of EAEC) because in these situations, none of the ingress nodes knows enough information to be able to compute the updated \overline{F}ₑ, Gₑ and Rₑ based on just the request and/or the paths (therefore, one needs to use CAM-IU or EDM-CU).

Conflict Resolution

As in almost all distributed implementations, conflicts among multiple signaling packets may arise due to the so-called race conditions. More specifically, two or more ingress nodes may send out “connection set-up” (or “bandwidth reservation”) packets at about the same time after each receives a connection establishment request. Although each ingress node may have the most up to date information needed at the time it computes the paths for the request it received, multiple ingress nodes will make decisions at about the same time independently of the other ingress nodes, and hence, compete for bandwidth on the same link.

If multiple signaling packets requests for bandwidth on the same link, and the residual bandwidth on the link is insufficient to satisfy all requests, then one or more late-arriving, low-priority, or randomly chosen signaling packets will be dropped. For each such dropped request, an negative acknowledgment (or NAK) will be sent back to the corresponding ingress node. In addition, any prior modifications made as a result of processing the dropped packet will be undone. The ingress node, upon receiving the NAK, may then choose to reject the connection establishment request, or wait till it receives updated information (if any) before trying a different active and/or backup path to satisfy the request. Note that if adaptive routing (hop-by-hop, or partially explicit routing) is used, the node where signal packets compete for bandwidth of an outgoing link, may choose a different outgoing link to route some packets, instead of dropping them (and sending NAKs to their ingress nodes afterwards).

Extensions to Multiple Classes of Connections

We now describe how to accommodate two additional classes of connections in terms of their tolerance to faults: unprotected and pre-emptable. An unprotected connection does not need a backup path so if (and only) the active path is broken due to a failure, traffic carried by the unprotected connection will be lost. A pre-emptable connection is unprotected, and in addition, carries low-priority traffic such that even if a failure does not break the connection itself, it may be pre-empted because its bandwidth is taken away by the backup paths corresponding to those (protected) active connections that are broken due to the failure.

The definitions above imply that an unprotected connection needs a dedicated amount of bandwidth (just as an active path), and that a pre-emptable connection can share bandwidth with any backup paths (but not with other pre-emptable connections).

Let Uₑ and Pₑ denote the sum of the bandwidth required by unprotected and pre-emptable connections, respectively, which use link e. Like Fₑ, Gₑ and Rₑ, each node n (edge or core) maintains Uₑ and Pₑ for link eεh(n). In addition, each ingress node (or a controller) maintains Uₑ and Pₑ for all links eεE.

Accordingly, define Gₑ(P)=max{Gₑ,Pₑ} and Rₑ(U)=Cₑ−Fₑ−Gₑ(P)−Uₑ. When handling a request for a protected connection, one may follow the same procedure outlined above for DPIM and its variations after replacing Rₑ with Rₑ(U) and Gₑ with Gₑ(P) in backup cost determination, path determination, and bandwidth allocation/de-allocation (though Gₑ still needs be updated and maintained in addition to Pₑ and Gₑ(P)).

One can deal with an unprotected connection request in much the same way as a protected connection with the exception that there is no corresponding backup path (and that Uₑ, instead of Fₑ, will be updated accordingly).

Finally, one can deal with a request to establish a pre-emptable connection requiring w units of bandwidth as follows. First, for every link eεE, one calculates bw=Pₑ+w−Gₑ(P). It then assigns max{bw,0} as a cost of link e in the graph N representing the network, and finds a cheapest path, along which the pre-emptable connection is then established in much the same way as an unprotected connection (with the exception that Pₑ and Gₑ(P) will be updated accordingly).

Application and Extension to Other Distributed and Centralized Schemes

All the DPIM schemes described can be implemented by using just one or more controllers to determine the paths (instead of the ingress nodes). Similarly, one can place additional controllers at some strategically located core nodes, in addition to the ingress nodes, to determine the paths. This is feasible especially when OSPF is used to distribute the topology information as well as additional information (such as Fₑ, Gₑ and Rₑ). This will facilitate partially explicit routing through those core nodes with an attached controller. More specifically, each connection can be regarded as having one or more segments, whose two end nodes are equipped with co-located controllers. Hence, the controller at the starting end of each segment can then find a backup segment by using the proposed DPIM scheme or its variations.

One can also extend the methods and techniques described previously to implement, under distributed control, a scheme based on either NS or SCI. While extension to a distributed scheme based on NS is fairly straight-forward, implementing a scheme based on SCI which we call distributed complete information management or DCIM, by maintaining δ^{b}ₐ for all links a and b (for a total of |E|² values), becomes similar to the SR/SSR scheme described in the prior art. The difference, however, is that while in SR/SSR, information on δ^{b}ₐ is exchanged via LSAs (i.e., using CAB), we propose to use a dedicated signaling protocol as described earlier (e.g., CAM-IU, or any EDM-based method) to multicast tile updated δ^{b}ₐ to all ingress nodes to achieve a variety of trade-offs between path computational overhead, signaling overhead, and timeliness of the information updates.

Finally, while DPIM already has a corresponding centralized control implementation (which is SPI), one can also implement, under centralized control, schemes corresponding to other variations of DPIM, such as DPIM-S, DPIM-A and DPIM-SA.

It will be appreciated that the instant specification, drawings and claims set forth by way of illustration and not limitation, and that various modification and changes may be made without departing from the spirit and scope of the present invention.

What we claim are:

1. A method to establish and release network connections with guaranteed bandwidth for networks under distributed control, wherein:
each ingress node acts as a distributed controller that performs explicit routing of network packets, each of said ingress node maintaining only partial information on existing paths, said partial information on existing paths comprising total amount of bandwidth on every link that is currently reserved for all backup paths, and the residual bandwidth on every link.

2. The method of claim 1, wherein said partial information on existing paths further comprises a total amount of bandwidth on every link dedicated to all active connections.

3. The method of claim 1 or 2, wherein said network connections are protected against single link or node failures.

4. The method of claim 1 or 2, wherein said network connections are unprotected against single link or node failures.

5. The method of claim 1 or 2, wherein said network connections are pre-emptable by a protected connection upon a link or node failure.

6. The method of claim 3, further comprising the steps of
determining routes for an active path and a backup path by a distributed controller, said backup path being link or node disjoint with said active path,
allocating or de-allocating bandwidth along said active path and said backup path using distributed signaling, and allowing bandwidth sharing among backup paths, and.
updating and exchanging partial and aggregated information between distributed controllers as a result of establishing or releasing a connection.

7. The method of claim 6, wherein the step of determining routes for an active path and a backup path utilizes methods based on Integer Linear Programming to minimize the sum of the bandwidth consumed by each pair of active path and backup path.

8. The method of claim 7, wherein the bandwidth consumed by the backup path is estimated based on the partial information available,
each link whose estimated backup bandwidth is 0 is assigned a small non-zero cost to reduce the backup length and thus the recovery time, and
the component in the objective cost function for the backup path is adjusted down by a fraction to reduce the total bandwidth consumption by all the connections.

9. The method of claim 6, wherein the step of determining routes for an active path and a backup path utilizes an algorithm to find a shortest pair of paths after assigning each link a cost, the said cost is w if the said link has a residue bandwidth that is no less than w, and infinity if otherwise (which logically remove the link).

10. The method of claim 6, wherein the step of determining routes for an active path and a backup path utilizes an algorithm that finds an active path first, comprising the steps of:
determing an active path using any well-known shortest path algorithm, after logically removing the links whose residue bandwidth is less than w, and assigning each of the remaining links a cost that includes the bandwidth required by the active path plus any potential amount of additional bandwidth required by the yet-to-be-determined backup path,
said potential amount of additional bandwidth being proportional to the maximum traffic carried on a given link a to be restored on any other link in case of failure of said given link and the bandwidth requested by the connection,
once an active path is determined, all the links along the active path are logically removed, the corresponding backup path is found similarily using any well-known shortest path algorithm after
each link is assigned either the requested bandwidth or an estimated cost if the cost is no greater than the residue bandwidth of the link, or infinity if otherwise.

11. The method of claim 1, wherein signaling packets are sent along the active path and backup path respectively,
said signalling packets sent along the active path contains the set of links along the backup path,
said signalling packets sent along the backup path contains the set of links along the active path, and each node along the backup path allocates minimum or de-allocates maximum amount of bandwidth based on the locally stored information at each node, independent of the estimated cost.

12. The method of claim 2. wherein each distributed controller at the edge maintains, for every link in the network, the amount of bandwidth allocated for backup paths, as well as the amount of residue bandwidth available.

13. The method of claim 2, wherein each distributed controller at the edge maintains, in addition, the maximum amount of traffic carried that needs to be restored on any given link for every link in the network.

14. The method of claim 2, wherein each distributed controller at a core or edge node maintains partial aggregated information on every local link, including the amount of bandwidth on every other link to be restored on the local link, and the amount of bandwidth carried on the local link that is to be restored on every other link.

15. The method of claims 12 and 13, further comprising methods to exchange the updated information among the edge and core controllers, wherein
each core node along a newly established or released active path and backup path will multicast to all edge controllers with locally updated information.

16. The method of claim 15, further comprising methods to exchange the updated information among the edge and core controllers, wherein
signaling packets can collect the updated information along their ways, then either the destination receiving the signaling packets or the source receiving the correspond acknowledgment for the signaling packets can multicast the updated information to all other edge controllers,
embedding the updated information in standard Link State Adverstisement packets used by the Internet Protocol, and
broadcasting said Link State Adverstisement packets to all other nodes at pre-determined intervals.
